(19) United States
(12) Patent Application Publication
(10) Pub. No.: US 2019/0022840 A1
(43) Pub. Date: Jan. 24, 2019

(54) MOBILE COMPRESSED AIR TOOL UNIT

(71) Applicant: PREBENA Wilfried Bornemann GmbH & Co. KG, Schotten (DE)

(72) Inventor: Werner Ruecklinger, Schotten (DE)

(21) Appl. No.: 16/018,296

(22) Filed: Jun. 26, 2018

(30) Foreign Application Priority Data
Jul. 20, 2017 (DE) 10 2017 212 522.5

(51) Int. Cl. B25C 1/04

(52) U.S. Cl. CPC B25C 1/04; F17C 1/00

(57) ABSTRACT

The invention relates to a mobile compressed air tool unit (10) comprising a tool (11) operated with compressed air and a compressed air storage unit (12), which are connected to each other via a compressed air connection (13), wherein the compressed air connection (13) is realized as a support for the tubeless connection of the tool (11) and the compressed air storage unit (12) in a defined relative arrangement and for design of the compressed air tool unit (10) as a handling unit, and to a pressure reducing unit (30) for forming a compressed air connection (13) between a tool (11) operated with compressed air and a compressed air storage unit (12).

The disclosure of German Patent Application 10 2017 212 552.5, filed Jul. 20, 2017, is incorporated herein by reference.

### TECHNICAL FIELD

The present invention relates to a mobile compressed air tool unit comprising a tool operated with compressed air and a compressed air storage unit, which are connected to each other via a compressed air connection.

### BACKGROUND

A generic mobile compressed air tool unit is known from U.S. Pat. No. 6,932,128 B2, which discloses a tool operated with compressed air and connected to a compressed air storage unit via a flexible tube connection, the compressed air storage unit being provided with a harness.

The known mobile compressed air tool unit does offer the advantage that the tool operated with compressed air can be operated via the connected compressed air storage unit independent of a mains connection. However, when using the tool, it is necessary for the storage unit to be carried on the body of the operator handling the tool.

Furthermore, the working radius or handling radius of the tool in relation to the location of the operator is limited by the length of the tube connection. For this reason, it is not possible, for example, for one operator to pass the tool to another operator without also passing the compressed air storage unit, which is attached to the first operator by means of the harness. Hence, handling of the tool by more than one operator is hardly possible in practice.

Therefore, the object of the present invention is to propose a mobile compressed air tool unit that allows easy handling of the compressed air tool unit by more than one operator.

### SUMMARY

To attain this object, the mobile compressed air tool unit according to the invention has a support for the tubeless connection of the tool and the compressed air storage unit in a defined relative arrangement and for design of the compressed air tool unit as a handling unit.

The mobile compressed air tool according to the invention differs from the known mobile compressed air tool unit in that it does not require a harness to be arranged on the operator in order for the tool, which is connected to the compressed air storage unit via a tube connection, to be used. Instead, the compressed air connection itself serves as a support for the mechanical connection of the tool and the compressed air storage unit. Thus, the compressed air connection realized as a support allows a tubeless connection between the compressed air storage unit and the tool, the support simultaneously allowing the tool to be handled together with the connected compressed air storage unit as a handling unit.

Unlike the known mobile compressed air tool unit, the mobile compressed air tool unit according to the invention can be easily used by more than one operator by simply passing the handling unit from one operator to the next operator without any special measures being required for doing so.

By realizing the compressed air connection as a support, the mobile compressed air tool unit can be passed in such a way, for example, that the tool is still being held by the first person while the next operator, in order to take over, grips the support with one hand so as to transfer the handling unit to the other hand, taking hold of the handle of the tool to do so, in order to operate the tool.

For this purpose, it may prove particularly advantageous if the support, which is realized as the compressed air connection, is designed as a handle.

According to a preferred embodiment, the compressed air connection is realized as a pressure reducing unit having a compressed air storage port and a compressed air tool port, which are arranged on a port side of a housing of the pressure reducing unit. Thus, it is possible for the compressed air storage and the tool on the handling unit to extend away from a shared housing side, thus permitting a compact design of the handling unit.

If the compressed air storage port and the compressed air tool port have parallel port axes, a particularly compact design of the handling unit becomes possible.

Preferably, the port axes are arranged perpendicular to the port side.

If the port axes have an axial distance from each other that corresponds to the axial distance between a longitudinal axis of a handle part of the connected tool, said handle part extending coaxially with the compressed air tool port, and a longitudinal axis of a magazine of the tool, the magazine extending substantially parallel to the handle part of the tool, the compressed air storage unit can be arranged substantially parallel to the magazine on the tool.

Preferably, the compressed air tool port of the compressed air connection is designed in such a manner that a relative rotation about the port axis of the compressed air tool port is possible between the tool and the compressed air connection connected to the tool via the compressed air tool port, allowing the compressed air storage unit to be pivoted from an arrangement parallel to a left longitudinal side of the magazine into an arrangement parallel to a right longitudinal side of the magazine, for example. This proves advantageous in particular when handling and using the tool in room corners, where the tool is to be used in an arrangement as adjacent as possible to a room wall without the compressed air storage unit being arranged between the room wall and the tool.

Furthermore, the object of the invention is attained in that the pressure reducing unit is used to form a compressed air connection between a tool operated with compressed air and a compressed air storage unit as a connecting bracket for the mechanical connection of the tool and the compressed air storage unit and for forming a compressed air tool unit, which comprises the tool and the compressed air storage unit.

Preferably, the pressure reducing unit has a housing having two housing sections arranged offset from each other in a shared housing plane and connected to each other in a housing middle portion, each housing section comprising, on its free end on a port side of the housing, a compressed air tool port and a compressed air storage port having parallel port axes in such a manner that the compressed air storage port is arranged in one housing section and the compressed air tool port is arranged in the other housing section. In this way, a particularly compact design of the housing having a smallest possible housing volume becomes possible, in which the largest longitudinal extension of the housing is substantially defined by the axial distance of the port axes.

Furthermore, a pressure reducer and a safety valve are preferably arranged in the housing middle portion.

### BRIEF DESCRIPTION OF THE DRAWING FIGURES

Hereinafter, other embodiments of the invention will be explained in more detail with the aid of the drawing.

In the drawing:

FIG. 1: shows an isometric illustration of the mobile compressed air tool unit realized as a handling unit, a compressed air storage unit arranged to its right;

FIG. 2: shows the compressed air tool unit illustrated in FIG. 1, the compressed air storage unit illustrated in a transitional position;

FIG. 3: shows the compressed air tool unit illustrated in FIG. 1, the compressed air storage unit arranged to its left;

FIG. 4: shows the mobile compressed air tool unit in an exploded illustration;

FIG. 5: shows a front view of a compressed air connection, realized as a pressure reducing unit, of the compressed air tool unit illustrated in FIG. 1;

FIG. 6: shows a sectional view of the pressure reducing unit illustrated in FIG. 5 according to section line VI-VI;

FIG. 7: shows a sectional view of the pressure reducing unit illustrated in FIG. 5 according to section line VII-VII.

### DETAILED DESCRIPTION

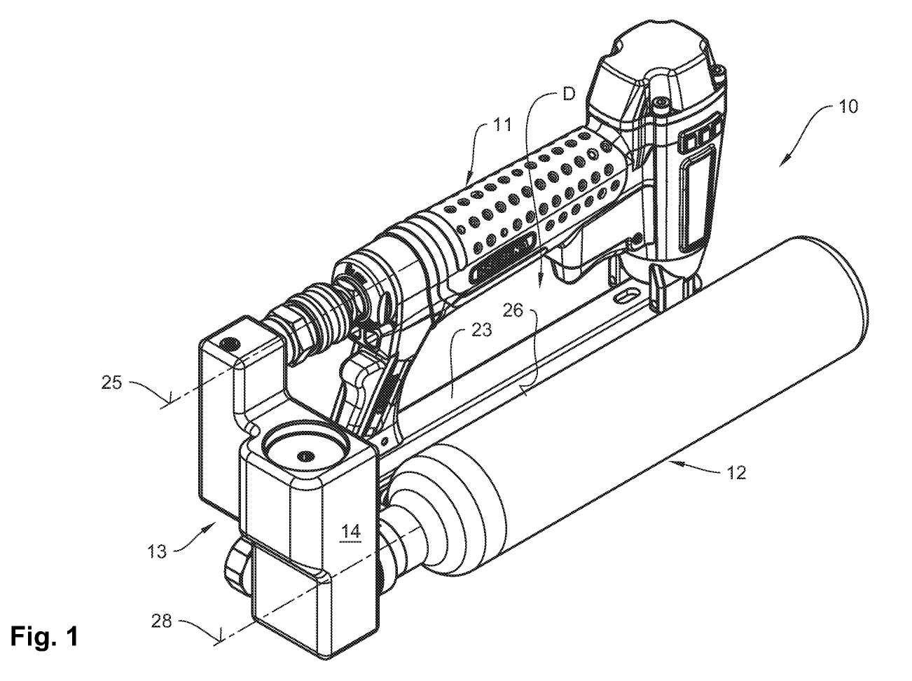

In FIGS. 1 to 3, a mobile compressed air tool unit 10 comprising a tool 11 operated with compressed air, a compressed air storage unit 12, and a compressed air connection 13 realized as a pressure reducing unit 30 is illustrated in different configurations.

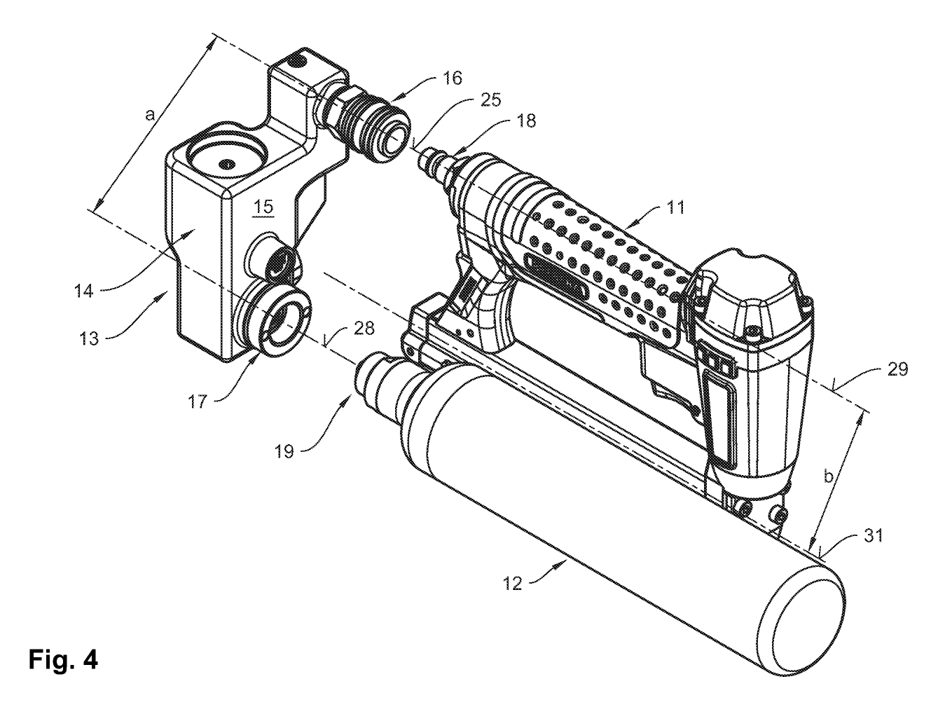

As shown in particular in FIG. 4, the compressed air connection 13 has a compressed air housing 14, which on a port side 15 is provided with a compressed air tool port 16, which is realized as a quick coupling in the case at hand, and with a compressed air storage port 17 for connecting a compressed air storage unit 12, which is realized as a cartridge in the case at hand. The tool 11 and the compressed air storage unit 12 are provided with suitable connectors 18 and 19, respectively, which, in the case of connector 18, can be plugged into the compressed air tool port 16 and, in the case of connector 19, can be screwed into the compressed air storage port 17.

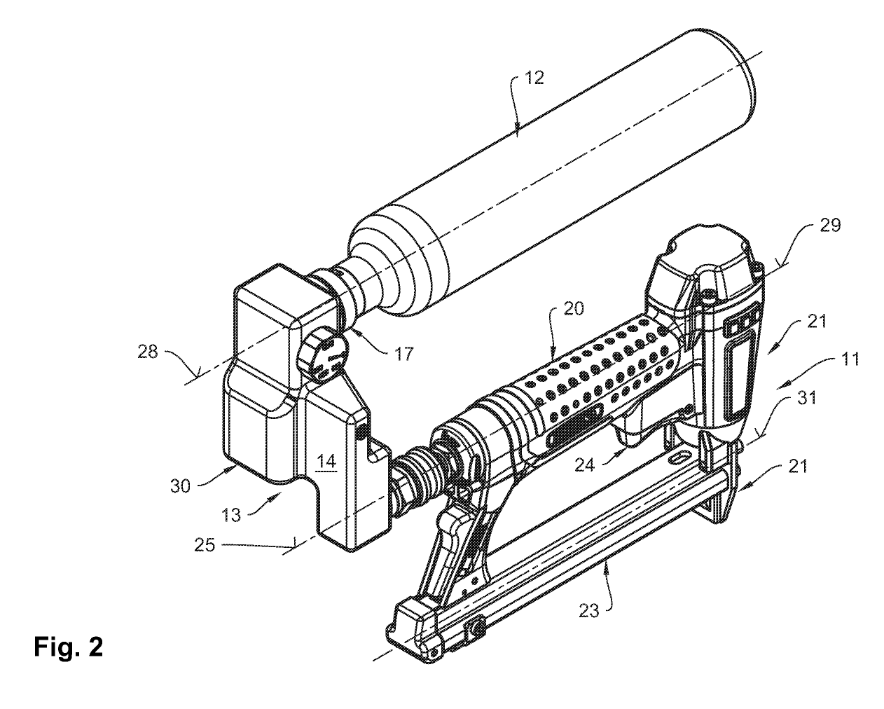

As can best be seen in FIG. 2, the tool 11 is realized, by way of example, as a compressed air nail gun in the case at hand, which has, at an axial end of a handle part 20, a drive piston unit 21 having a attachment tip 22 which serves to discharge fastening means, such as nails, stored in a magazine 23, which extends parallel to the handle part 20, the fastening means being driven out of a discharge channel of the attachment tip 22 when a trigger 24 arranged at the handle part 20 is actuated and being driven into a surface that is in contact with the attachment tip 22.

Generally, however, the flexibility of the compressed air tool unit is to be stressed, which means that it is also possible for the compressed air storage unit to be combined with a tool in the form of a compressed air grinder or a compressed air drill, for example, in order to form the compressed air tool unit defined by claim 1 and illustrated here merely in an embodiment example.

As becomes clear from the sequence of FIGS. 1 to 3, the arrangement of the compressed air storage unit 12 relative to the tool 11 can also be changed by pivoting the compressed air connection 13 together with the connected compressed air storage unit 12 about a port axis 25 of the compressed air tool port 16, thus pivoting it, for example, from the right-hand side position illustrated in FIG. 1, in which the compressed air storage unit 12 is located substantially parallel to a right longitudinal side 26 of the magazine 23, into a left-hand position, in which the compressed air storage unit 12 is located substantially parallel to a left longitudinal side 27 of the magazine 23.

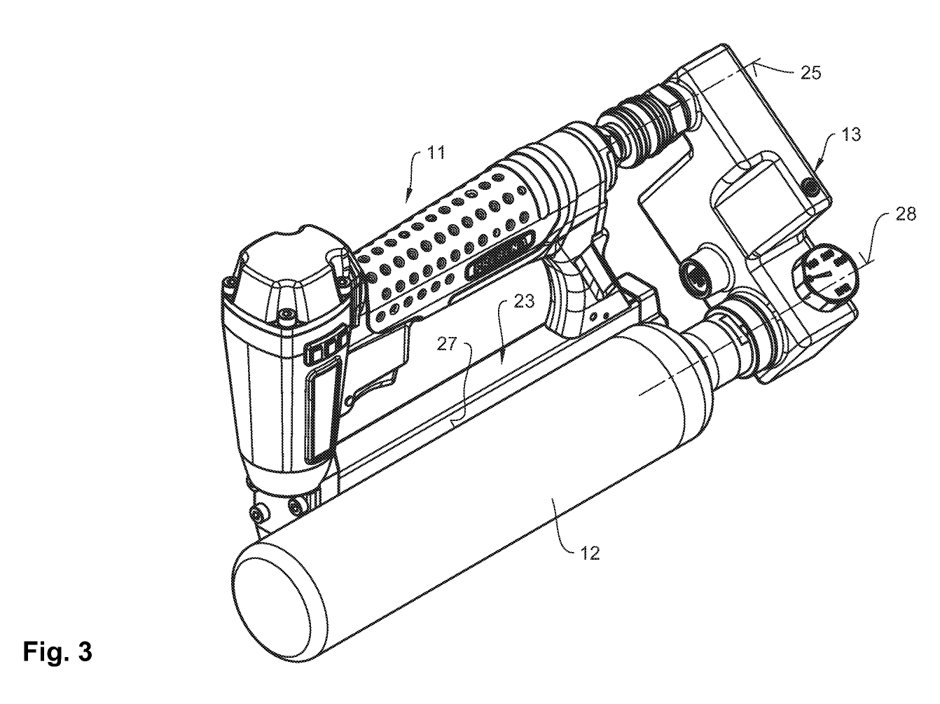

As becomes clear from FIGS. 1 to 4, the port axis 25 of the compressed air tool port 16 and a port axis 28 of the compressed air storage port 17 are located parallel to each other and have an axial distance a that substantially corresponds to the axial distance b between a longitudinal axis 19 of the handle part 20 and a longitudinal axis 29 of the magazine 23 in such a manner that in the right-hand position of the compressed air storage unit 12, illustrated in FIG. 1, and in he left-hand position of the compressed air storage unit 12, illustrated in FIG. 3, the compressed air storage unit 12 is located not only in an arrangement parallel to the magazine 23 but also in an arrangement overlapping the magazine 23, which means that the tool 11 neither protrudes beyond the magazine 23 in the downward direction, nor does it hinder access of an operator's hand gripping the handle part 20 to a finger space D formed between the handle part 20 and the magazine 23.

As can be seen in particular from a combination of FIGS. 1 and 4, the compressed air connection 13 forms a removable mechanical connecting bracket between the tool 11 and the compressed air storage unit 12, the connecting bracket allowing the formation of a handling unit comprising the tool 11 and the compressed air storage unit 12, which, in particular when the compressed air tool unit 10 formed as a handling unit is passed from one operator to another operator, enables the other operator to take over the compressed air tool unit by taking hold of the connecting bracket 36.

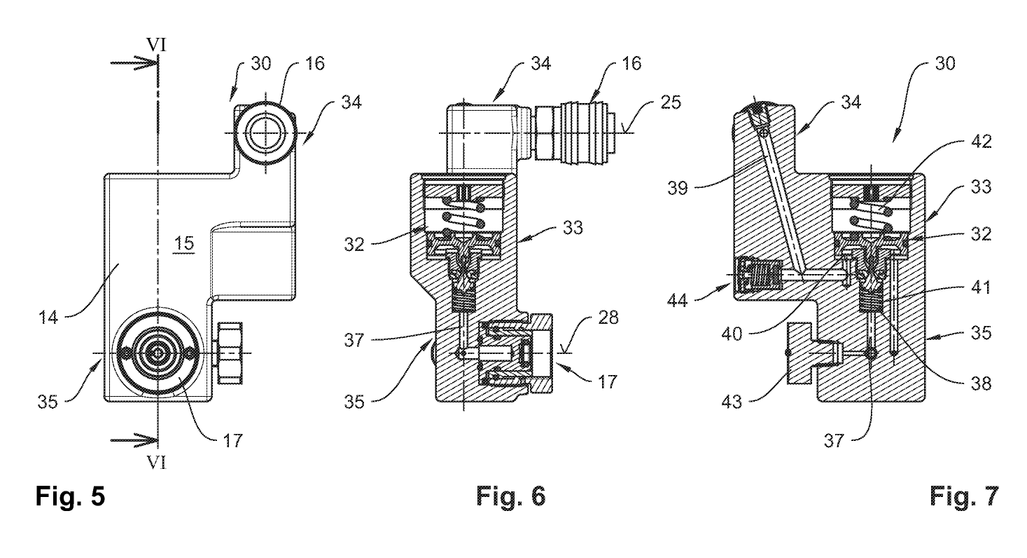

As will be explained in more detail hereinafter by reference to FIGS. 5 to 8, in the case at hand, the compressed air connection 13 is not only realized as a connecting bracket 36, but also simultaneously forms a pressure reducing unit 30 in the compressed air housing 14, which comprises a pressure reducer 32 in addition to the compressed air tool port 16 and the compressed air storage port 17.

As FIG. 7 shows, the pressure reducer 32 is located in a housing middle portion 33, whereas the compressed air tool port 16 and the compressed air storage port 17 are each arranged on a free end of a housing section 34 and of a housing section 35, respectively, which extend in opposite directions from the housing middle portion 33 and which are arranged in a shared housing plane.

As can be seen from a combination of FIGS. 6 and 7, the compressed air storage port 17, which serves to be connected to the compressed air storage unit 12, which is illustrated in FIGS. 1 to 4 and realized as a cartridge in the case at hand, is connected to a compressed air inlet 38 of the pressure reducer 32 via a storage air line 37 and the compressed air tool port 16 is connected to a compressed air outlet 40 of the pressure reducer 32 via a working air line 39. The pressure reducer 32 is set to a defined pressure difference in such a manner that storage air having 300 bar at the compressed air inlet 38, for example, is reduced to a working air pressure of 6.5 bar at the compressed air outlet 40. Of course, different pressure differences can be set as needed for a closing spring 41 and an adjusting spring 42 arranged in the pressure reducer 32 by suitable choice.

As can be seen in particular in FIG. 7, in the case at hand, the storage air line 37 is provided with a manometer 43 for displaying the filling pressure of the compressed air storage unit 12. In the working air line 39, a safety valve 44 is provided parallel to the compressed air tool port 16, the safety valve 44 preventing a compressed air overload of the tool 11 in case of failure of the pressure reducer 32.

1. A mobile compressed air tool unit (10) comprising a tool (11) operated with compressed air and a compressed air storage unit (12), which are connected to each other via a compressed air connection (13), characterized in that
the compressed air connection (13) is realized as a support for the tubeless connection of the tool (11) and the compressed air storage unit (12) in a defined relative arrangement and for design of the compressed air tool unit (10) as a handling unit.

2. The compressed air tool unit according to claim 1,
characterized in that
the compressed air connection is realized as a pressure reducing unit (30) having a compressed air storage port (17) and a compressed air tool port (16) which are arranged on a port side (15) of a housing (14) of the pressure reducing unit (30).

3. The compressed air tool unit according to claim 2,
characterized in that
the compressed air storage port (17) and the compressed air tool port (16) have parallel port axes (25, 28).

4. The compressed air tool unit according to claim 3,
characterized in that
the port axes (25, 28) are arranged perpendicular to the port side (15).

5. The compressed air tool unit according to claim 4,
characterized in that
the port axes (25, 28) have an axial distance a from each other which corresponds to the distance b between a longitudinal axis (29) of a handle part (20) of the connected tool (11), said handle part extending coaxially with the compressed air tool port (16), and a longitudinal axis (31) of a magazine (23) of the tool (11), said magazine extending substantially parallel to the handle part (20).

6. The compressed air tool unit according to claim 5,
characterized in that
the compressed air tool port (16) of the compressed air connection (13) is designed in such a manner that a relative rotation about the port axis (25) of the compressed air tool port (16) is possible between the tool (11) and the compressed air connection (13) connected to the tool (11) via the compressed air tool port (16).

7. A pressure reducing unit (30) for forming a compressed air connection (13) between a tool (11) operated with compressed air and a compressed air storage unit (12),
characterized in that
the pressure reducing unit (30) is realized as a connecting bracket for the mechanical connection of the tool (11) and the compressed air storage unit (12) and for the formation of a compressed air tool unit (10) according to claim 1, which comprises the tool (11) and the compressed air storage unit (12) and which forms a handling unit.

8. The pressure reducing unit according to claim 7,
characterized by
a housing (14) having two housing sections (34, 35) arranged offset from each other in a shared housing plane and connected to each other in a housing middle portion (33), each housing section (34, 35) comprising, at its free end on a port side (15) of the housing (14), a compressed air tool port (16) and a compressed air storage port (17) having parallel port axes (25, 28) in such a manner that the compressed air storage port (17) is arranged in one housing section (35) and the compressed air tool port (16) is arranged in the other housing section (34).

9. The pressure reducing unit according to claim 8,
characterized in that
a pressure reducer (32) and a safety valve (44) are arranged in the housing middle portion (33).
